(19) United States
(12) Patent Application Publication
(10) Pub. No.: US 2022/0410170 A1
(43) Pub. Date: Dec. 29, 2022

(54) STIRRED BALL MILL, STIRRED BALL MILL STIRRING UNIT, AND METHOD FOR COMMINUTING MILLING MATERIAL

(71) Applicants: thyssenkrupp Industrial Solutions AG, Essen (DE); thyssenkrupp AG, Essen (DE)

(72) Inventor: Falk SILBERMANN, Hamm (DE)

(73) Assignees: thyssenkrupp Industrial Solutions AG, Essen (DE); thyssenkrupp AG, Essen (DE)

(21) Appl. No.: 17/793,166

(22) PCT Filed: Jan. 22, 2021
(86) PCT No.: PCT/EP2021/051484

§ 371 Date: Jul. 15, 2022

(30) Foreign Application Priority Data
Jan. 24, 2020 (DE) 10 2020 200 878.7

(51) Int. Cl. B02C 17/16

(52) U.S. Cl. CPC B02C 17/163; B02C 2017/165

(57) ABSTRACT

A stirred ball mill may include a milling jar, at least three agitator shafts, and a drive. The milling jar may be arranged in a main direction and may have a milling chamber that is adapted to receive milling material and milling aid elements. Each of the at least three agitator shafts has a center axis that is arranged parallel to the main direction of the milling jar and is configured as a screw that is mounted fixedly to a frame in the milling jar such that each agitator shaft is rotatable about its center axis. The drive is configured to rotate the agitator shafts about their respective center axes without any contact between the agitator shafts. The center axes of the agitator shafts may be arranged as side edges of a prism.

The invention lies in the field of comminuting technology, and relates to stirred ball mills comprising milling jars, agitator shafts and drives. In a stirred ball mill of this type, a milling jar is arranged in a main direction and has a milling chamber for receiving milling material, an agitator shaft has a center axis arranged parallel to the main direction of the milling jar and is configured as a screw which can be rotated about the center axis, and a drive is configured to rotate the agitator shaft about its center axis. Furthermore, the invention relates to a stirred ball mill stirring unit for a stirred ball mill of this type, and to a method for comminuting milling material, the method comprising suspending of the milling material to be comminuted in a milling liquid, a milling material dispersion being obtained, continuous introducing of the milling material dispersion into a lower section of a milling chamber, filled with milling aid elements, of a stirred ball mill, continuous vertical conveying of a part of the milling material dispersion out of the lower section of the milling chamber into an upper section of the milling chamber, a processed milling material dispersion being obtained, in which at least one part of the milling material which is dispersed in the milling aid liquid is comminuted, continuous discharging of a part of the processed milling material dispersion from the upper section of the milling chamber, and concluding separating of the comminuted milling material from the discharged processed milling material dispersion.

A stirred ball mill (stirred ball mill, stirred mill, agitator mill) is an apparatus for comminuting and/or homogenizing solids as milling material. To this end, the milling material is mixed with milling aid elements (milling elements, milling balls), and this mixture is set in movement with the aid of a steering unit in the milling chamber of the stirred ball mill. During this movement, the milling aid elements and the milling material bump repeatedly into one another and into the boundary walls of the milling chamber. As a result of the forces which occur during the movement (the impact forces on account of impact stress and the shear forces which occur between the milling material and the milling aid elements and also between the milling material and the stirred ball mill), the milling material is comminuted, with the result that the stirred ball mill is a special form of ball mill. Milling assemblies of this type are used, for instance, in the processing of mineral raw materials and pigments, but also in the processing of herbal raw materials, for instance in the papermaking industry or in the food industry. Stirred ball mills inherently afford a particularly large number of advantages if milling material which has brittle fracture behavior is to be comminuted.

Stirred ball mills have milling jars which can be arranged vertically or horizontally. The interior space (milling chamber) of the milling jars frequently has the form of a cylinder, a polygonal prism or shapes which are derived therefrom. During operation, the interior space is predominantly filled with milling aid elements with a spherical or ball-like basic shape, typically from approximately 70% to 90% of the volume of the interior space. The milling aid elements as a rule consist of a ceramic, metallic or mineral material which should be chemically inert, low-abrasion and wear-resistant with respect to the material to be comminuted. The intensive movement and thorough mixing of the milling aid elements and the milling material takes place by way of the agitator shaft of a milling unit, which agitator shaft has suitable agitator elements.

Milling jars which are arranged horizontally (in a level or recumbent manner) are preferably used during wet milling of milling material dispersions with high mobility. Milling jars which are arranged vertically (in a perpendicular or upright manner) can also be used, moreover, for systems with poor mobility and poor flow behavior. Depending on the specific application, vertically arranged milling jars can be used in a “wet” operating mode (wet operation) for milling material dispersions, or can be used in “dry” operating mode (dry operation) for fine milling material. Stirred ball mills with vertically arranged milling jars are preferably used in the case of milling tasks, in the case of which milling material with certain degrees of fineness are to be industrially obtained inexpensively.

During wet operation of stirred ball mills with vertically arranged milling jars, the milling material to be communicated (in the form of particles or chunks—the terms “particle” or “chunk” are used here synonymously) is introduced as a dispersion (suspension, slurry) into the milling jar. Here, the input of material takes place as a rule continuously, for example in the base area of the milling chamber via an inlet in the lower end wall of the milling jar. Here, the solid fraction which is distributed in a milling material dispersion of this type is comminuted and dispersed with the aid of milling aid elements. Depending on the respective configuration of the stirred ball mills, the discharge of the comminuted milling material takes place above the inlet, as a rule in the upper region of the milling jar. The milling aid elements are typically separated from the comminuted milling material at the discharge of the milling jar, for instance with the aid of a screen. In the case of a procedure of this type, the product (that is to say, the communicated milling material) is present in a size distribution due to the process.

The impact forces and shear forces which are required to comminute the milling material are input into the stirred ball mill by way of the steering unit. The steering unit typically has an agitator shaft and a drive. The agitator shaft comprises agitator elements such as, for instance, axially arranged thread turns (as single-start or multiple-start screws), a plurality of disks which are oriented in parallel on the agitator shaft with passage openings, or pins which are oriented radially on the agitator shaft. The agitator elements are set in rotational movement via the agitator shaft, as a result of which intensive thorough mixing of the milling aid elements and the milling material which is distributed in the milling material dispersion occurs, in the case of which the milling material is de-agglomerated and comminuted. The rotational movement of the agitator shaft is ensured via a suitable drive which has a drive unit, as a rule a suitable motor.

During the operation of the stirred ball mill, the milling aid elements are greatly loaded mechanically as a consequence of the intensive thorough mixing, and therefore have to be replaced from time to time. In order to keep the abrasion on the inner wall of the milling jar and on the agitator shaft and on the agitator elements low, the inner wall and the agitator shaft usually have high-strength linings or coatings made from low-abrasion and wear-resistant materials.

For fine milling of mineral milling material such as, for example, ores, stirred ball mills with vertically arranged milling jars are used for instance, the steering unit of which comprises an agitator shaft which has one or more thread turns as agitator element, with the result that the agitator shaft is configured as a likewise vertically arranged screw (worm, helix, coil, spiral), and also frequently as a multiple-start screw. This screw rotates in a ball bed consisting of milling aid elements, the milling material dispersion being situated with the milling material to be comminuted in the space between the individual milling aid elements. As a consequence of the rotational movement of the screw, the milling aid elements are set in motion, as a result of which an action of force is exerted on the milling material dispersion, which action of force leads to a comminution of the milling material. Stirred ball mills with steering units which ensure high drive power outputs are required for applications of this type, in particular.

Drive units which are suitable for stirring units of stirred ball mills typically have maximum drive power outputs of approximately 1500 HP (corresponding to 1120 kW); for special applications, staring units with drive power outputs of up to 4500 HP (corresponding to 3360 kW) can also be used occasionally. The power output of drive units of this type is not sufficient, however, in order to permit a variation of the throughput in the stirred ball mill within certain limits if the mixtures of milling aid elements and milling material dispersions are not very mobile (that is to say, for instance, mixtures with a high solid proportion, with milling aid elements or milling material particles of a great diameter and irregular shapes, and/or in which the overall mass to be moved of the mixture is high; in contrast to mixtures with high mobility, that is to say, for instance, mixtures, in which the volume proportion of liquid phase is relatively high, in which both the dispersed milling material particles and the milling aid elements are relatively smooth and sufficiently small, and in which the overall mass to be moved of the mixture is sufficiently low); mixtures of this type can also occur, in particular, in the processing of mineral raw materials. Precisely in the case of mixtures of this type with a low mobility, relatively powerful stirred ball mills cannot therefore readily be realized by way of currently commercially available drive units: in order for it to be possible for a stirred ball mill with an input of particularly great milling energy or milling performance and with a particularly high throughput to be constructed for mixtures of this type with low mobility, the diameter of the agitator shaft is as a rule increased, namely the diameter of the thread turn of the screw. The mass of a screw rises, however, with the square of the screw diameter, for which reason considerably more power for the drive units are required in order to drive a relatively large screw. The selection of powerful drive units of this type is small in the marketplace, for which reason custom-made models usually have to be used here. If stirred ball mills with a relatively high performance can be realized at all in technical terms, this therefore involves disproportionately high costs.

As an alternative, there is also the possibility, instead of an increase in the screw diameter of the agitator shafts, of increasing the throughput of the stirred ball mill, by a drive unit being used which can drive the agitator shaft at high rotational speeds (revolutions per minute). In order to change the rotational speed of the drive assembly, correspondingly variable frequency converters would then also be required in addition to more powerful drive units. On account of the costs which are involved with more powerful drive units of this type, the use of variable frequency converters is not appropriate for economic reasons, however. Therefore, only drive units with a fixed rotational speed are used in current stirred ball mills, which leads to more difficult process control.

Accordingly, it is the object of the present invention to provide a stirred ball mill which eliminates these disadvantages, which stirred ball mill makes a particularly high throughput and/or an input of particularly great milling energy or milling performance possible in a simple way, in particular even in the case of the use of conventional drive units for mixtures with low mobility, and which stirred ball mill also allows, above all, a regulation of the rotational speed.

This object is achieved by way of a stirred ball mill, a stirred ball mill stirring unit, and a method for comminuting milling material with the features which are specified in the independent claims. Advantageous developments result from the subclaims, the following description and the drawings.

The invention comprises a stirred ball mill comprising a milling jar, at least three agitator shafts and a drive, the milling jar being arranged in a main direction and having a milling chamber which is adapted to receive milling material and milling aid elements, each of the at least three agitator shafts having a center axis which is arranged parallel to the main direction of the milling jar, and being configured as a screw which is mounted fixedly to the frame in the milling jar and such that it can be rotated about the center axis, the drive being configured to rotate the at least three agitator shafts about their respective center axes, and the at least three agitator shafts not making contact with one another, and the center axes of the at least three agitator shafts being arranged as side edges of a prism.

A stirred ball mill is understood to mean all constructions known to a person skilled in the art for comminuting and/or homogenizing solids as milling material, in the case of which constructions the milling material is set in motion in the interior of a milling jar together with milling aid elements by means of a steering unit with agitator shafts and at least one drive. Stirred ball mills of this type can be operated, for instance, discontinuously (for instance, in batch operation), continuously (for instance, with a temporally constant variable inlet and discharge) or else quasi-continuously.

The milling jar is a housing, the interior space of which is configured as a milling chamber and is therefore adapted for receiving a mixture of firstly milling material or milling material dispersion and secondly milling aid elements (in addition, depending on the milling task, the mixture can also have further constituent parts, for example function-changing components such as additives during cement production or auxiliary materials). The milling jar (and therefore the milling chamber) has a main direction (main direction of extent), in which it is arranged. In the case of a horizontally arranged milling jar, the main direction of the milling jar is horizontal (or at least substantially horizontal with a deviation of at most 10° from the horizontal), and, in the case of a vertically arranged milling jar, the main direction of the milling jar is vertical (or at least substantially vertical with a deviation of at most 10° from the vertical). Moreover, other arrangements are also possible, for instance an “oblique” orientation of the milling jar, in the case of which other arrangements the main direction of the milling jar differs from the vertical and from the horizontal, or arrangements with an orientation which changes over the extent of the milling chamber. Milling jars can fundamentally be constructed in any desired manner; for example, its housing shell can be formed from individual segments or can be of single-piece configuration. The milling jar can be configured for wet operation or dry operation. The invention preferably relates to stirred ball mills with vertically arranged milling jars, in particular those which are configured for wet operation.

A milling chamber usually has the shape of a cylinder or polygonal prism (the main direction of the milling chamber therefore runs in the direction of the axis of said geometric structure) or shapes which are derived therefrom; it can also have other shapes, however. For continuous operation or quasi-continuous operation, the milling chamber can have an intake and a discharge. “Fresh” milling material is introduced into the milling chamber via the intake, and comminuted milling material is discharged from the milling chamber via the discharge. In the case of stirred ball mills with vertically arranged milling jars in wet operation, the milling material is fed in in a dispersed form, and the milling material dispersion is discharged with the comminuted milling material. The milling material dispersion which is discharged from the milling chamber with the comminuted milling material can be fed to a size segregation operation. In the case of the size segregation operation, milling material particles which have at most the respective desired target size are separated from larger milling material particles, and the latter are returned into the milling chamber again. For the case where the milling material dispersion which is discharged from the milling chamber at the discharge or a part thereof is to be branched off from the outlet flow and is to be returned again into the milling chamber, the milling material dispersion to be returned can be mixed with fresh milling material (as a rule, in the form of a dispersion) before the return, the combined material flows then being introduced via a common intake into the milling chamber; the fresh milling material can of course also be fed in separately, and a separate return intake can be provided for the material flow to be returned. In the case of vertically arranged milling jars, the intake is frequently situated in the lower region of the milling chamber (for instance in the bottom of the milling chamber or in the side wall of the milling chamber close to the bottom), and the discharge is situated in the upper region of the milling chamber (for instance in the side wall of the milling chamber). In the milling chamber, the mixture of milling material dispersion and milling aid elements is therefore conveyed from the bottom toward the top counter to gravity. In the case of other embodiments of vertically arranged milling jars, the intake can also be situated in the upper region of the milling chamber and the discharge can be situated in the lower region of the milling chamber.

The discharge can have a screen device, in which the milling aid elements are separated from the milling material dispersion to be discharged consisting of comminuted milling material and milling aid liquid, and can be retained in the milling chamber; a separation of this type can fundamentally also take place only outside the milling jar, for which purpose, however, a separate return of the discharged milling aid elements would then be necessary. The addition of fresh milling aid elements into the milling chamber can take place via a separate intake opening, but other arrangements are also possible; for example, the milling material dispersion can for instance already be mixed with the milling aid elements before the introduction into the milling chamber, and the mixture of milling material dispersion and milling aid elements can then be introduced into the milling chamber via the intake.

Furthermore, the stirred ball mill has at least three agitator shafts and a drive. The drive has at least one drive unit and, moreover, can comprise further elements, for example a rotational speed change unit (for instance, a frequency converter), a control unit for controlling the drive unit (for instance, by means of control electronics or logic circuits) or machine elements for changing motion variables (for instance, gear mechanisms). The drive is operatively connected to the agitator shaft, with the result that the drive power which is provided by the drive is transmitted to the agitator shafts. The operative connection between the agitator shaft and the drive can be of any desired configuration; for example, it can comprise a direct coupling (by, for instance, the agitator shaft being flange-connected to the shaft or the axle of the drive) or a coupling via a gear mechanism. Here, a coupling can take place, for instance, at one end section of the agitator shaft, or via the two end sections of the agitator shaft. Every machine which is configured and is suitable (in particular, with regard to the design of its output) to set the agitator shaft or agitator shafts operatively connected to it in a rotational movement about the rotational axis, for example a motor, can fundamentally be provided as drive unit.

The agitator shafts are elongate elements which are configured such that they can be rotated about the rotational axis, and are suitable for forwarding rotational movements and torques from the drive to the mixture of milling aid elements and milling material or milling material dispersion in the milling chamber of the milling jar. Here, the rotational axis of an agitator shaft is as a rule arranged parallel to its main direction of extent and represents the center axis of the agitator shaft. The agitator shaft has an agitator section which is adapted for dipping into the mixture of milling aid elements and milling material or milling material dispersion, and its outer enveloping shape is frequently of similar configuration to that of a cylinder or conical section. The rotatable mounting of an agitator shaft can take place at one point or as a plurality of points; in the case of agitator shafts of stirred ball mills with a vertically arranged milling jar, the agitator shafts are frequently mounted only at their upper end, but other embodiments are also fundamentally possible here.

As essential functional constituent parts, an agitator shaft has agitator elements which transmit the drive energy introduced by the drive during the rotation of the agitator shaft about the center axis which is configured as a rotational axis to the medium to be thoroughly mixed in the milling chamber, that is to say to the mixture of milling aid elements and milling material or milling material dispersion. Here, the mixture is set in motion, with the result that the constituent parts of the mixture are thoroughly mixed. In the present case, the agitator elements are formed in such a way that the agitator shaft is configured as a screw which can be rotated about the center axis of the agitator shaft, with the result that the center axis of the screw coincides with the center axis/rotational axis of the agitator shaft (the two center axes therefore have at any rate a small positional deviation of a few percent of the external diameter of the screw, in particular of less than 5% of the external diameter of the screw). All customary embodiments are fundamentally suitable as screw (worm, helix, coil, spiral), whether as single-start screws or multiple-start screws, for example two-start screws, three-start screws or four-start screws, the abovementioned screws being, for instance, those with a cylindrical basic shape and those with a slightly conical basic shape, with a filled center region or with an unfilled center region (“with a core” or “without a core”), right-handed screws just like left-handed screws of a respective suitable helical curve, helical surface or coil surface, thread height and thread angle, which, depending on the available drive power, composition of the mixture and the thorough mixing to be achieved, can be selected suitably in a way which is known to a person skilled in the art. Here, the at least three screws can be of identical or else different configuration, for example with regard to the screw type, screw geometry (thread turn geometry) or the screw dimensions, that is to say, for instance, their overall length or their diameter. In order to improve the web behavior, those regions of the agitator shaft which are particularly loaded during the transmission of force can be of low-wear configuration; for example, they can have a high-strength thread turn coating and/or tip coating.

It has now been discovered that the milling material is not comminuted uniformly over the entire extent of the milling chamber or the screw, but rather that the loading space which is suitable for the milling processes is situated, above all, in a narrow region on the screw outer side. Furthermore, it has been discovered that the milling energy which is input by the drive via the agitator shaft into the mixture of milling material/milling material dispersion and milling aid elements is proportional to the outer circumference of the agitator shaft which is configured as a screw. The milling energy which is input therefore rises linearly with the diameter of the screw, while the space requirement (the required base side, that is to say their base area in the case of stirred ball mills with vertically arranged milling jars) of a stirring unit of this type rises with the square of the diameter of the screw. Here, an efficient transmission of torque between firstly the drive unit and the agitator shaft and secondly the mixture of milling material/milling material dispersion and milling aid elements is required for a high input of energy, for which reason the agitator shafts have to be mounted fixedly to the frame in the milling jar, the interior space of which is configured as the milling chamber. Fixed to the frame denotes a shaft, the position of which does not change relative to the frame (the machine frame, that is to say the load-bearing parts of the stirred ball mill and its milling jar, in particular the milling chamber); this does not of course rule out a rotational movement of the shaft about its center axis. For this reason, the agitator shafts cannot be circulating shafts either, and therefore may not circulate on circular paths within the milling chamber in the machine frame, with the result that, for instance, an arrangement of the shafts on the circulating part of a planetary gear mechanism (epicyclic gear mechanism) is fundamentally not possible here.

In the case of the comparison of the input energies for agitator shaft systems with an identical space requirement but a different agitator shaft diameter, it can be seen that it is more advantageous to use a plurality of smaller agitator shafts than one larger agitator shaft: for example, for a first system consisting of four small screws as agitator shafts which in each case have a diameter of d_{s,k}=D, the overall circumference U_{S,k} of the four smaller agitator shafts is calculated as U_{S,k}=4×(π D), whereas a second system consisting of a large screw as agitator shaft with the diameter of d_{S,g}=(2D) which has the same space requirement as the first system, has a circumference U_{S,g} of the agitator shaft of U_{S,g}=1×(π(2D)). Since the input of energy is proportional to the overall circumference of the agitator shafts, the input of energy for the first system is twice as great as that for the second system, with an identical space requirement. If particularly great milling energies or milling performances are to be realized in a milling chamber of a given base side and volume, it is therefore appropriate for a plurality of smaller agitator shafts to be used in the available milling chamber instead of a single larger agitator shaft, with the result that the performance efficiency can be increased as a consequence of the distribution to a plurality of smaller agitator shafts.

In an arrangement of this type, the stirred ball mill therefore has more than two agitator shafts, that is to say at least three agitator shafts, but more agitator shafts can also be provided, for example four agitator shafts, five agitator shafts or six agitator shafts. The agitator shafts are designed as screws which can be configured structurally in any desired manner in a suitable form; for example, the agitator shafts can have a hollow shaft or a solid shaft. Here, the drive is configured to rotate the at least three agitator shafts about their respective center axes; for this purpose, each agitator shaft can have a separate drive unit, but a plurality of agitator shafts or even all agitator shafts can also have a common drive unit. The agitator shafts do not make contact with one another, with the result that there is a gap between two adjacent agitator shafts; here, adjacent screws can also be arranged, in particular, in such a way that their thread turns do not engage into one another or penetrate one another. In a stirred ball mill, the gaps between the different agitator shafts can in each case be of equal size or else can be configured with different sizes. The center axes of the agitator shafts are arranged in the milling chamber of the milling jar in each case parallel to the main direction of the milling jar, with the result that the center axes of the at least three agitator shafts likewise run parallel to one another; a parallel course is considered here to be a course which has at most a deviation of 5° from an exactly parallel orientation. Here, the center axes of said at least three agitator shafts are arranged as side edges of a prism (as a polygonal arrangement). In the present case, a prism is understood to mean a polyhedron, the shape of which is obtained during the parallel displacement of a planar regular or irregular polygon as base area along a straight line as displacement line, the straight line not lying in the plane of the polygon; in the case of a straight prism, the displacement takes place perpendicularly with respect to the plane of the polygon and, in the case of an oblique prism, the displacement takes place at an angle which differs from the perpendicular. Here, the polygon is the base face and also the top face of a prism of this type, and the remaining boundary faces form the shell faces, in each case two shell faces being connected to one another via in each case one side edge which extends from a corner of the base face toward a corner of the top face. The side edges are parallel to one another and all have the same length. The base face in the top face are as a rule congruent, but exceptionally they can also be turned with respect to one another (with the result that the term “prism” can also comprise prismatoids). The prism, as the side edges of which the at least three agitator shafts are arranged, can have a regular structure (its base face is therefore a regular polygon, for instance an equilateral triangle, square, a regular pentagon, regular hexagon or the like) or else an irregular structure (its base face is therefore an irregular polygon, for instance a scalene triangle, in particular also an isosceles triangle, a scalene quadrilateral, in particular a scalene rectangle, a parallelogram or a trapezium, and other irregular closed polygonal curved lines), with the result that the prism therefore also comprises cuboids, trigonal prisms, pentagonal prisms, hexagonal prisms and the like. The arrangement of the center axes of the at least three agitator shafts as side edges of a prism is necessary, in order for it to be possible for the torques of the three agitator shafts to be used as effectively as possible with respect to the milling operation, which would not be possible, for instance, in the case of a purely linear arrangement on account of the smaller number of vicinity zones between adjacent agitator shafts (in the “gap” between adjacent agitator shafts, where the outer sides of adjacent screws approach one another, and milling material and milling aid elements are subjected to the influence of different agitator shafts) and therefore on account of the smaller overall area of all the vicinity zones.

In addition to a suitable geometric configuration, the adaptation of the milling chamber for receiving milling material and milling aid elements as a rule also comprises the use of suitable chemically inert and mechanically durable materials which are low-abrasion and wear-resistant with respect to the material to be comminuted. The inner wall of the interior space is typically provided with a corresponding high-strength coating or lining for this purpose, it being possible for said lining to be configured to be, for instance, segmented or as a full lining element. A corresponding high-strength lining or coating is likewise used for the agitator shaft, in particular for its center axis, its thread turn and its tip. The material for linings or coatings of this type is as a rule selected in accordance with the material of the milling aid elements, in order to minimize the mutual wear effects. The surface of wear-subjected elements of this type typically consists of metals or alloys, for instance deals such as high-alloy steels, in particular chromium steels, of ceramic materials or minerals, for instance carbide materials, in particular tungsten carbide, chromium carbide, tantalum carbide, niobium carbide, titanium carbide, hafnium carbide or mixed carbides thereof, oxidic materials, in particular corundum (above all, sintered corundum), titanium dioxide or zirconium dioxide (in a stabilized form, for instance with yttrium oxide or scandium oxide, or else in an non-stabilized form), agate or flint, and of composite materials, for instance hard metals.

Here, the milling aid elements themselves are not an integral constituent part of the stirred ball mill, but are indispensable in operation. Milling aid elements are typically used, the outer side of which has a rounded form in order to homogenize the movement behavior, for example spherical or ball-like milling aid elements, cylindrical milling aid elements (“cylpebs”) and ellipsoid, ovoid or spindle-shaped milling aid elements and the like. During operation, they typically fill from approximately 70% to 90% of the volume of the milling chamber, this quantity ratio having a considerable influence on the product quality. The ultimately achieved size distribution of the milling material is dependent, above all, on the size and shape of the milling aid elements and on the milling material itself (for instance, on its density, hardness, brittle fracture behavior, crystallinity and crystal morphology, and on the size of the milling material which is fed in). The material selection of the milling aid elements is as a rule selected in accordance with the material of the coating.

In the simplest embodiment, all of the at least three agitator shafts are driven by the same drive unit. In accordance with a further aspect, the stirred ball mill is configured in such a way that the drive for each of the at least three agitator shafts comprises a dedicated drive unit. In this way, each agitator shaft can be actuated individually, which makes a particularly versatile process control possible. If a rotational speed control means is additionally provided here in at least one drive unit (possibly also in all the drive units), a constant morphology can be ensured dynamically even in the case of temporarily non-constant milling conditions (for instance, a changing quality of the milling material which is fed in) for the comminuted milling material. Moreover, the use of separate drive units for each agitator shaft makes it possible for an overall input of energy which is as high as possible to be achieved by way of commercially available drive units, with the result that a particularly high milling performance can be realized. Here, the drive units can be of identical configuration or can also be different. The latter can be appropriate even when, for instance, not all the agitator shafts have the same screw diameter or the same screw geometry, but rather are to be attributed to at least two different types with regard to diameter or geometry.

Instead, the stirred ball mill can also be configured, however, in such a way that the drive for at least two of the at least three agitator shafts comprises a common drive unit, with the result that at least two drive units are provided in the case of each stirred ball mill. In the case of a stirred ball mill with three agitator shafts, as a consequence, two agitator shafts are then driven by a common drive unit, and the last agitator shaft has a dedicated drive unit. In the case of a stirred ball mill with four agitator shafts, three agitator shafts are driven by a common drive unit, and the remaining agitator shaft then has a dedicated drive unit, or else two agitator shafts are driven by a common drive unit and the remaining two agitator shafts then either have in each case a dedicated drive unit or instead are driven by a second common drive unit; this applies accordingly to stirred ball mills with more than four agitator shafts, that is to say, for instance, with five agitator shafts, with six agitator shafts or with seven agitator shafts. In the case of an embodiment of this type, it is sufficient for merely one of the at least two drive units to be configured for operation at a controllable rotational speed (revolutions per minute), in order to ensure a change in the loading speed within the mixture of milling material/milling material dispersion and milling aid elements in the milling chamber. An embodiment of this type has fewer drive units than the embodiment, in the case of which each agitator shaft has a dedicated drive unit, for which reason the space requirement can also be lower and this embodiment can also be less expensive on account of the lower number of drive units. At the same time, however, this embodiment also provides process control which is significantly more powerful than a stirred ball mill with at least three agitator shafts which are all driven by a single drive unit, for which reason this variant is an appropriate compromise.

In accordance with a further aspect, the stirred ball mill is configured in such a way that the drive is configured to drive at least one agitator shaft of the at least three agitator shafts at a rotational speed which can be controlled independently of the rotational speeds of the other agitator shafts of the at least three agitator shafts. This can be achieved, for example, by way of the use of individual drive units or agitator shaft gear mechanisms which can be switched independently of one another. Particularly individual process control can be achieved in this way.

In accordance with a further aspect, the stirred ball mill is configured in such a way that, in addition to the at least three agitator shafts, the stirred ball mill has at least one inner agitator shaft which in each case has a center axis which is arranged parallel to the main direction of the milling jar, and is configured as a screw which is mounted fixedly on the frame in the milling jar and can be rotated about the center axis, the at least one inner agitator shaft not making contact with the at least three agitator shafts, and the center axis of the at least one inner agitator shaft being arranged within the prism which is formed by the center axes of the at least three agitator shafts. Therefore, the at least one inner agitator shaft is thus not arranged on a side edge of the prism, the shell of which is defined by the at least three (outer) agitator shafts. Here, the at least one inner agitator shaft can be of identical configuration to one agitator shaft or to a plurality of agitator shafts from the at least three (outer) agitator shafts, or can be different therefrom, for example with regard to the screw type, screw geometry (thread turn geometry) or the screw dimensions, that is to say, for instance, their overall length or their diameter. If more than one inner agitator shaft is provided (for example, two inner agitator shafts or three inner agitator shafts), they can be of identical or else different configuration. This embodiment affords the advantage that the inner region between the outer agitator shafts does not lack milling material as a consequence of the rotation of the outer agitator shafts, with the result that no “empty inner region” arises as a dead volume or dead zone. An arrangement with at least one inner agitator shaft is even more appropriate if more than four outer agitator shafts are provided, since the volume of the inner region then also becomes greater, that is to say, for instance, in the case of stirred ball mills with five agitator shafts, with six agitator shafts, with seven agitator shafts or with eight agitator shafts.

Here, the stirred ball mill can additionally comprise a braking device which is configured to decrease the rotational speed or to prevent a rotational movement in the case of the at least one inner agitator shaft. Every suitable braking device can fundamentally be used for this purpose, for instance mechanical braking systems, magnetic braking systems, electric braking systems, fluid braking systems or the like. In this way, the rotatable inner agitator shaft can be braked in a targeted manner during operation, as a result of which it is possible to directly influence the flow of the mixture of milling material/milling material dispersion and milling aid elements in the interior space between the at least three (outer) agitator shafts, in order to locally counteract the configuration of dead zones there, or in order to influence the input of energy and the transmission of torque by way of additional turbulence (for example, when starting up or shutting down the stirred ball mill or in order, during operation, to force or to prevent a transition for the mixture to a cascade motion, to a cataract motion or to centrifugation).

Here, the stirred ball mill can be configured in such a way that the drive has a drive unit, in order to rotate the at least one inner agitator shaft about its center axis. Said drive unit can be a separate drive unit or else a common drive unit, via which at least one or else a plurality of the outer agitator shafts and also the inner agitator shaft are driven; for example, said common drive unit can be connected to the inner agitator shaft directly or else via a corresponding gear mechanism. An input of energy can also take place via the inner drive shaft by way of this embodiment; moreover, this makes even more targeted influencing of the flow of the mixture of milling material/milling material dispersion and milling aid elements in the milling chamber possible, in order for it to be possible for dead zones to be avoided. Instead, however, the stirred ball mill can also be configured in such a way that the at least one inner agitator shaft is not connected to a drive. In the case of this embodiment, a rotation of the inner agitator shaft about its center axis is then achieved passively by way of unpowered co-rotation of the inner agitator shaft in the flow motion of the mixture of milling material/milling material dispersion and milling aid elements. In this way, the inner agitator shaft serves to homogenize a material flow which circulates in the milling chamber, and can therefore lead to passive stabilization of milling operation; moreover, the configuration of dead zones can be counteracted.

Here, the at least three agitator shafts can fundamentally be adapted for a rotational movement in identical rotational directions (in each case in the clockwise direction or counter to the clockwise direction) or in different rotational directions. Here, the adaptation of the agitator shaft for certain rotational directions primarily concerns its screw shapes, the configuration as a right-handed screw or as a left-handed screw; moreover, a corresponding adaptation also concerns the structural configuration of the drive for the respective rotational directions, that is to say of the control unit, the drive units and/or any elements for power transmission and/or torque transmission (for example, of gear mechanisms which are arranged between the drive assembly and the agitator shaft).

If the at least three agitator shafts are adapted for different rotational directions, at least one agitator shaft of the at least three agitator shafts is a right-handed screw, and at least one agitator shaft of the at least three agitator shafts is a left-handed screw. As a result, it is then possible in the case of an even number of agitator shafts that each agitator shaft has a rotational direction which differs from the rotational directions of the two agitator shafts which adjoin it. If adjacent agitator shafts have different rotational directions, the outer sides of their screws run in the same running direction with respect to one another where they approach one another (that is to say, in the “gap” between adjacent agitator shafts), with the result that particularly homogeneous milling conditions prevail locally at these points. Instead, however, the stirred ball mill can also be configured in such a way that the at least three agitator shafts are adapted for a rotational movement in the same rotational direction. If adjacent agitator shafts have the same rotational directions, the outer sides of their screws then run in a different running direction with respect to one another in the vicinity zone. As a result, the solid constituent parts (that is to say, the milling material and the milling aid elements) which are subjected to the influence of different agitator shafts have local relative speeds to one another in the vicinity zone, which relative speeds are almost twice as high as the speed of the solid constituent parts in the flow of the agitator shafts outside the vicinity zone. This results in significantly greater local impact forces and shear forces in this zone and therefore also in a considerably higher input of milling energy, without a greater area being required for the assembly than in the case of conventional single-shaft stirred ball mills, with the result that an embodiment of this type produces considerable advantages.

In the case of stirred ball mills with at least three (outer) agitator shafts which have the same rotational direction, the risk is particularly high that dead zones are configured in the inner region between the agitator shafts (for instance, in accordance with a vortex formation on account of the doughnut effect). If a stirred ball mill therefore has at least three (outer) agitator shafts which are adapted for a rotational movement in the same rotational direction, it can be appropriate (as described above) if at least one inner agitator shaft is also additionally provided. Here, the at least one inner agitator shaft can be adapted for a rotational movement in the same rotational direction as the at least three (outer) agitator shafts (it certainly being possible for the at least one inner agitator shaft have a different rotational speed than the at least three (outer) agitator shafts). In this way, the input of energy can be increased even further, since additional vicinity zones are produced in comparison with an arrangement without an inner agitator shaft. Instead, however, the stirred ball mill can also be configured in such a way that the at least three agitator shafts are adapted for a rotational movement in the same rotational direction, and the at least one inner agitator shaft being adapted for a rotational movement in the rotational direction which is different than the rotational direction of the at least three agitator shafts. In this way, the same high input of milling energy is provided as in the case of a stirred ball mill with at least three (outer) agitator shafts with the same rotational direction, the configuration of dead zones being counteracted.

In accordance with a further aspect, the stirred ball mill can be configured in such a way that the external diameter of each of the at least three agitator shafts is at most half the maximum internal width of the milling chamber. In this way, it is ensured that the predominant part of the input of energy does not take place via a single agitator shaft, but rather substantially via each of the at least three agitator shafts in similar proportions, with the result that an optimum increase in throughput and/or milling energy or milling performance can be achieved.

Furthermore, the invention comprises a stirred ball mill stirring unit for the above-described stirred ball mill, the stirred ball mill stirring unit comprising at least three agitator shafts and a drive, each of the at least three agitator shafts having a center axis, being configured as a screw which can be rotated about the center axis, and being configured for mounting fixedly to the frame in a milling jar, the drive being configured to rotate the at least three agitator shafts about their respective center axes, and the at least three agitator shafts not making contact with one another, and the center axes of the at least three agitator shafts being oriented parallel to one another and being arranged as side edges of a prism, it being possible, in particular, for the drive for each of the at least three agitator shafts to comprise a dedicated drive unit, or it being possible for the drive for at least two of the at least three agitator shafts to comprise a common drive unit, and it being possible, in particular, for the drive to be configured here to drive at least one of the at least three agitator shafts at a rotational speed which can be regulated independently of the rotational speeds of the others of the at least three agitator shafts, it being possible, in particular, for the stirred ball mill steering unit to have, in addition to the at least three agitator shafts, at least one inner agitator shaft which in each case has a center axis which is arranged parallel to the main direction of the milling jar, is configured as a screw which can be rotated about the center axis, and is configured for mounting fixedly to the frame in a milling jar, the at least one inner agitator shaft not making contact with the at least three agitator shafts, and the center axis of the at least one inner agitator shaft being arranged within the prism which is formed by the center axes of the at least three agitator shafts, and it being possible here, in particular, for the drive not to be connected to the at least one agitator shaft or to have a drive unit, in order to rotate the at least one inner agitator shaft about its center axis, and it being possible here, in particular, for it to comprise a braking device which is configured, in order to decrease the rotational speed to prevent a rotational movement in the case of the at least one inner agitator shaft, it being possible, in particular, for the external diameter of each of the at least three agitator shafts to be at most half the maximum internal width of the milling chamber.

Accordingly, the stirred ball mill stirring unit comprises at least three agitator shafts and a drive. Each of the at least three agitator shafts has a center axis, and is configured as a screw which can be rotated about the center axis. Furthermore, each of the at least three agitator shafts is configured for mounting fixedly to the frame in a milling jar. The drive is configured to rotate the at least three agitator shafts about their respective center axes. The at least three agitator shafts do not make contact with one another, and the center axes of the at least three agitator shafts are oriented parallel to one another and are arranged as side edges of a prism.

The drive for each of the at least three agitator shafts can optionally comprise a dedicated drive unit, or the drive for at least two of the at least three agitator shafts can comprise a common drive unit. Furthermore, the drive can optionally be configured, in particular, to drive at least one of the at least three agitator shafts at a rotational speed which can be controlled independently of the rotational speeds of the others of the at least three agitator shafts. Here, the stirred ball mill steering unit can optionally likewise have, in addition to the at least three agitator shafts, at least one inner agitator shaft which in each case has a center axis which is arranged parallel to the main direction of the milling jar. In this case, the at least one inner agitator shaft is then configured as a screw which can be rotated about the center axis, and is configured for mounting fixedly to the frame in a milling jar, said inner agitator shaft not making contact with the at least three agitator shafts, the center axis of the at least one inner agitator shaft being arranged here within the prism which is formed by the center axes of the at least three agitator shafts. Furthermore, the drive can optionally have a drive unit here, in order to rotate the at least one inner agitator shaft about its center axis, or else cannot be connected to the at least one inner agitator shaft. The drive can likewise optionally also comprise a braking device which is configured, in order to decrease the rotational speed or to prevent a rotational movement in the case of the at least one inner agitator shaft. Finally, the external diameter of each of the at least three agitator shafts can optionally also be at most half the maximum internal width of the milling chamber. A corresponding steering unit has already been explained in greater detail in conjunction with the description of the stirred ball mill.

Finally, the invention comprises a method for comminuting milling material in a stirred ball mill with a vertically arranged milling jar in wet operation, the method comprising (i) suspending of the milling material in a milling aid liquid, a milling material dispersion being obtained, (ii) continuous introduction of the milling material dispersion into a lower section of a milling chamber, filled with milling aid elements, of a stirred ball mill, in particular the above-described stirred ball mill, (iii) continuous vertical conveying of a part of the milling material dispersion from the lower section of the milling chamber into an upper section of the milling chamber by way of at least three rotating, vertical agitator shafts which are mounted fixedly to the frame, do not make contact with one another, are oriented at least substantially vertically parallel to one another, and the center axes of which are arranged as side edges of a prism, a processed milling material dispersion being obtained, in which at least one part of the milling material dispersed in the milling aid liquid is comminuted, (iv) continuous discharging of a part of the processed milling material dispersion from the upper section of the milling chamber, and (v) concluding separating of the comminuted milling material from the discharged processed milling material dispersion.

Accordingly, the milling material to be comminuted is first of all suspended in a milling aid liquid, a milling material dispersion being obtained. All suitable liquids, pure substances, solutions, mixtures and disperse systems can be used as milling aid liquid, in particular liquids of the type which are chemically inert with respect to the constituent part to be comminuted of the milling material; this is not affected by the fact that the milling aid liquid is possibly also used for cleaning and reconditioning of the milling material, for instance by it being possible for any contaminants therein to be decomposed or released from the milling material, adsorbed or bound in some other way and therefore separated from the milling material.

If the milling material is a mineral raw material, it is frequently crushed rock here which has previously been crushed in a braking apparatus (for instance, in a gyratory crusher) and has been fed to a separating apparatus for classification (for example, a classifier or screen), the crushed rock with the desired particle size is possibly being fed to a further pre-comminution means, for example a horizontal ball mill or roller mill, before it is finally introduced as milling material into the milling material dispersion. The suspension can then take place immediately before the introduction into the milling chamber of the stirred ball mill or just before that, for instance in a mixing chamber or a milling material dispersion tank. If further method steps are carried out before the comminution of the milling material in the stirred ball mill, for instance those for milling material preparation, cleaning or pre-comminution, the suspension of the milling material in the milling aid liquid can take place in the process sequence temporally before the introduction of the milling material dispersion into the stirred ball mill. The milling material dispersion is typically subjected to a pre-classification before the introduction into the stirred ball mill (for example, in a centrifugal separator, for instance a hydrocyclone), in order to separate milling material portions which already have the desired target size. After the separation, the milling material dispersion can be discharged with the milling material which already has the desired target size as a product dispersion from the stirred ball mill system, and can be fed for further use.

After the suspension, the milling material dispersion (or its coarse fraction) is introduced continuously into the lower section of the milling chamber of a stirred ball mill. To this end, the milling material dispersion is typically conveyed by means of pumps which are positioned upstream of the stirred ball mill through pipelines to the inlet of the milling jar and from there is fed into the milling chamber. The milling aid elements (together with product dispersion which was fed to the milling chamber at an earlier time and has not yet left it again) are already situated in the milling chamber. Here, the milling aid elements are frequently selected in such a way that they have greater dimensions than the milling material to be comminuted. Here, the actual stirred ball mill can have one of the embodiments which have already been described in detail above.

In the milling chamber, during the rotation of the agitator shafts about their respective center axes, the milling material dispersion is conveyed continuously out of the lower section of the milling chamber in the vertical direction into an upper section of the milling chamber. To this end, the at least three agitator shafts are oriented at least substantially vertically parallel to one another, and are mounted fixedly to the frame in such a way that they do not make contact with one another, the center axes of the at least three agitator shafts being arranged as side edges of a prism. When the at least three agitator shafts are set in a rotational movement about the center axes, a part of the milling material dispersion is conveyed upward and is comminuted here by way of the milling aid elements as a consequence of the impact stress and shear stress occurring in the process. Here, a processed milling material dispersion is obtained, in which at least part of the milling material which is dispersed in the milling aid liquid is comminuted (in relation to the particle size of the originally fed milling material). Above all, those portions of the milling material which already have smaller particle sizes are conveyed upward, and, just like the milling aid elements, the portions of the milling material with the greater particle sizes remain, above all, in the lower part of the milling chamber. In the case of many stirred ball mills, a pump is provided for the milling material dispersion merely in the intake system; in contrast, the removal of the milling material dispersion takes place in a passive manner via an overflow system, without a further pump being provided in the discharge system. Therefore, the mean dwell time of the milling material in the milling chamber can be controlled, above all, by way of the adjustable pump power output of the pump in the intake flow.

After running through the vertical transport section, a part of the processed milling material dispersion is discharged continuously from the upper section of the milling chamber. The discharge (outlet, drain) typically has a screen apparatus, with the result that the larger milling aid elements cannot leave the milling chamber via the discharge, but rather remain in the milling chamber. As an alternative or in addition, the discharge can also be arranged in the milling chamber at a sufficient spacing from the actual milling volume (the part region of the milling chamber where the agitator elements of the agitator shaft are arranged and bring about pronounced thorough mixing of the mixture of milling material dispersion and milling aid elements) above the milling volume, with the result that the milling aid elements do not leave the milling chamber via the discharge on account of their mass, but rather remain in the milling chamber. Since the milling aid elements are also subject to wear, new milling aid elements can be introduced into the milling chamber, for which purpose a separate milling aid elements inlet can be provided, for instance, in the upper section of the milling chamber.

The processed milling material dispersion with the comminuted milling material is then fed, after the discharge from the milling chamber, to a post-classification means, in which the portions of the comminuted milling material which already have the desired target sizes (fine material) are separated, in order to be discharged as product flow from the stirred ball mill. The portions of the comminuted milling material which do not yet have the desired target sizes, but which are rather still too large (coarse material), are as a rule fed to the milling chamber again. In terms of apparatus, it has proved to be favorable here if the pre-classification and the post-classification are carried out together. To this end, the entire milling material suspension which is discharged from the milling chamber with the comminuted milling material is conducted directly into a tank, into which the fresh milling material suspension with the milling material which has not yet been comminuted is also fed. The two milling material suspension flows are mixed with one another there, and are fed jointly to the single classification apparatus (for instance, the abovementioned hydrocyclone), in which the pre-classification then takes place at the same time as the post-classification.

The abovementioned method sequence can be supplemented and modified in a way known to a person skilled in the art in accordance with the respective boundary conditions for the separating task, without deviating from the invention in the process, as long as the abovementioned steps (i), (ii), (iii), (iv) and (v) are realized in the process, the greatest significance being attached to step (iii).

The invention is to be described in greater detail in the following text with reference to the appended drawings of particularly advantageous examples, without restriction of the general inventive concept which forms the basis of said examples, further advantages and possible uses also additionally arising therefrom. In the drawings, in each case diagrammatically:

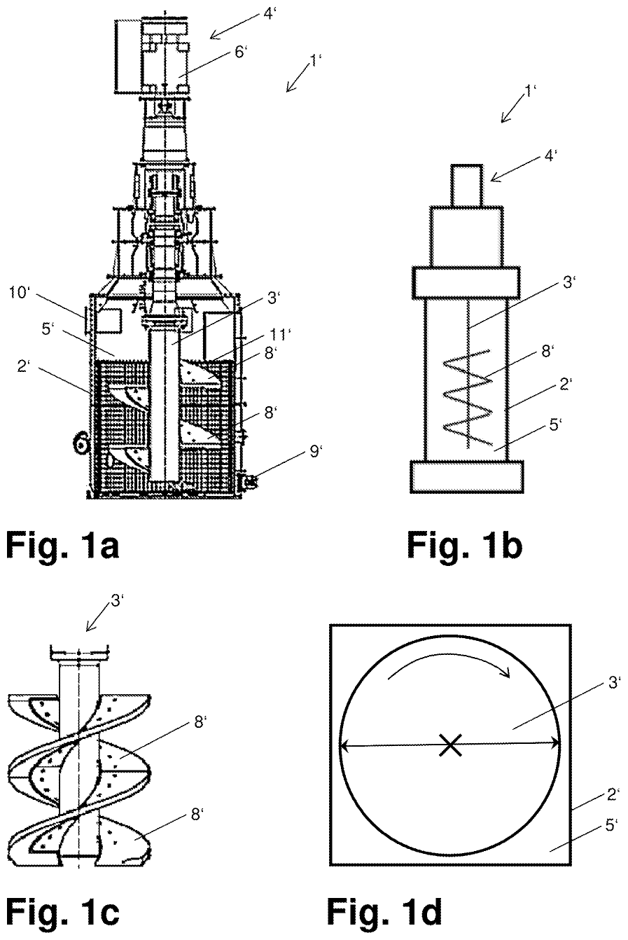

FIG. 1 shows different diagrammatic illustrations of a conventional stirred ball mill, namely a lateral sectional view of a conventional stirred ball mill in FIG. 1a, a simplified symbolic side view of a conventional stirred ball mill in FIG. 1 b, a lateral detailed view of the agitator shaft of a conventional stirred ball mill in FIG. 1c, and a simplified horizontal section through a conventional stirred ball mill in FIG. 1d,

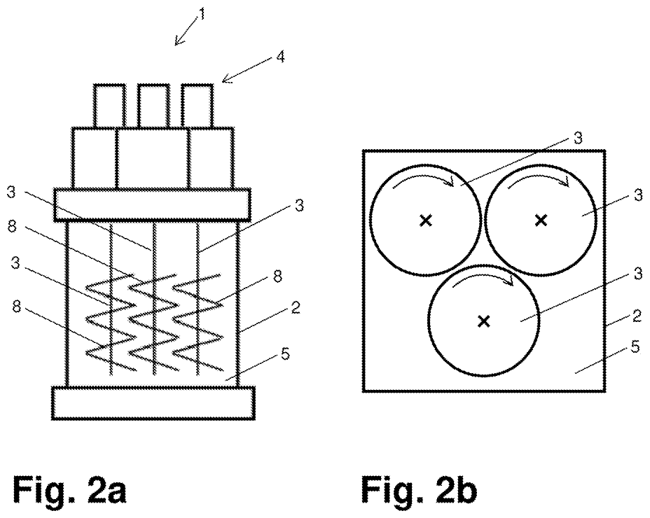

FIG. 2 shows diagrammatic illustrations of stirred ball mills with three agitator shafts, namely a simplified symbolic side view of a stirred ball mill with three agitator shafts in FIG. 2a, and a simplified horizontal section through a stirred ball mill with three agitator shafts in FIG. 2b,

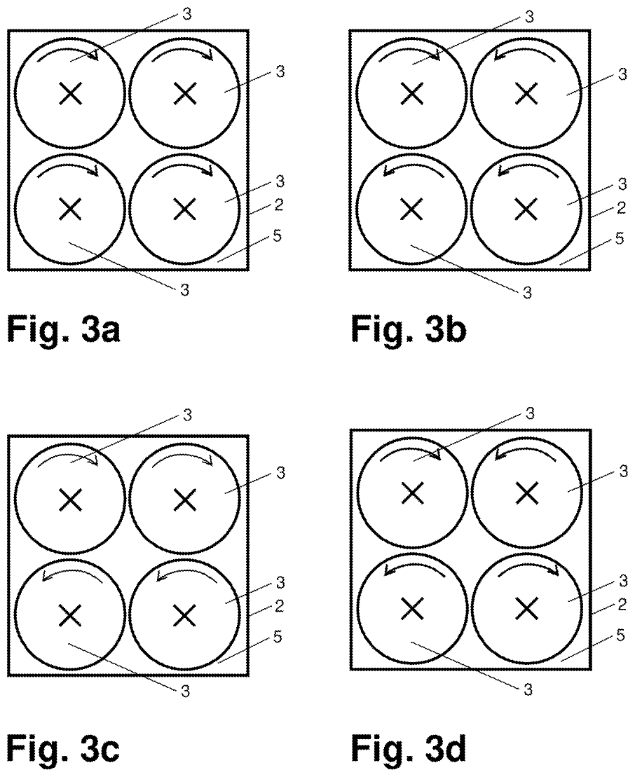

FIG. 3 shows diagrammatic simplified horizontal sections through stirred ball mills with four agitator shafts which differ with regard to the rotational directions of the four agitator shafts, namely for a first embodiment in FIG. 3a, for a second embodiment in FIG. 3b, for a third embodiment in FIG. 3c, and for a fourth embodiment in FIG. 3d, and

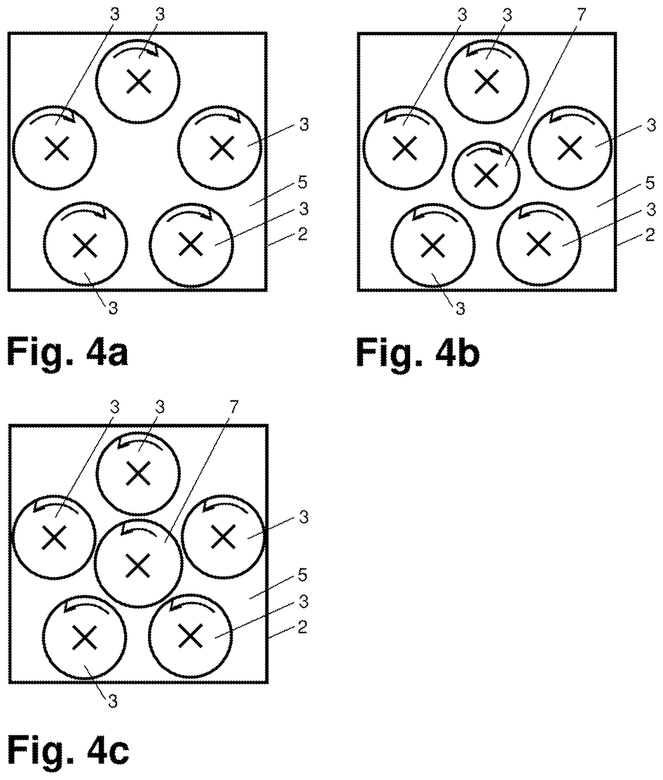

FIG. 4 shows diagrammatic simplified horizontal sections through stirred ball mills with five outer agitator shafts, namely FIG. 4a, FIG. 4b and FIG. 4c, FIG. 4c additionally having an inner agitator shaft.

FIG. 1 shows different diagrammatic illustrations of a conventional stirred ball mill from the prior art and details in this respect. Here, FIG. 1 a shows a conventional stirred ball mill 1′ in a lateral sectional view. The stirred ball mill 1′ is a stirred ball mill with a vertically oriented screw. The stirred ball mill 1′ has a milling jar 2′ which is arranged vertically, with an interior space which is configured as a milling chamber 5′. A single agitator shaft 3′, the center axis of which is likewise oriented vertically as a rotational axis, is arranged in the milling chamber 5′. The milling chamber 5′ is covered toward the top by a covering, on which the drive 4′ for the single agitator shaft 3′ is situated. For this purpose, the drive 4′ has a drive unit 6′ which is configured as an electric motor and is the uppermost termination of the stirred ball mill 1′. Moreover, the drive has a vertical axle, by which the drive unit 6′ is operatively connected to the single agitator shaft 3′. The upper end of the single agitator shaft 3′ is fastened by means of a flange connection to the lower end of the axle in such a way that the torque which is provided by the drive unit 6′ is transmitted to the single agitator shaft 3′. The individual agitator shaft 3′ is configured as a screw, namely as a screw of cylindrical basic shape with a filled center region. This screw has two thread turns 8′, with the result that it is a two-start screw. The drive 4′ and the agitator shaft 3′ together form the stirred ball mill stirring unit. An opening which forms the intake 9′ of the milling chamber 5′ is provided in the side wall of the milling jar 2′ close to the bottom, configured as a base surface, of the milling jar 2′. During operation, a mixture of milling material dispersion and milling aid elements (not shown) is fed continuously to the milling chamber 5′ through said opening. As a consequence of the rotational movement of the agitator shaft 3′, the mixture of milling material dispersion and milling aid elements in the milling chamber 5′ is conveyed from bottom to top in the vertical direction and is subjected in the process to pronounced impact stress and shear stress, the milling material being comminuted. In order to reduce the wear of the stirred ball mill 1′, the wall of the milling chamber 5′ is lined with a milling chamber lining 11′ made from a high-strength material. In its upper region, the milling jar 2′ has a further opening which forms the discharge 10′ of the milling chamber 5′. Said opening is arranged outside the milling volume. A screen is situated in front of said opening, with the result that the milling aid elements are retained in the milling chamber 5′, and merely the milling material dispersion with the at least partially comminuted milling material is discharged from the milling chamber via the discharge 10′.

FIG. 1b shows a simplified symbolic side view of the conventional stirred ball mill 1′ (shown in FIG. 1a). In FIG. 1b, many structural elements are omitted for the sake of improved clarity, and what is shown is merely the stirred ball mill 1′ with the milling jar 2′, in the interior space 5′ of which the single agitator shaft 3′ with the thread turn 8′ is situated, which agitator shaft 3′ is set in a rotational movement via the drive 4′ which is arranged on the milling jar 2′. The drive 4′ and the agitator shaft 3′ together also form the stirred ball mill stirring unit here.

FIG. 1c shows a lateral detailed view of the agitator shaft 3′ of the conventional stirred ball mill (shown in FIG. 1a). The agitator shaft 3′ is configured as a two-start screw of cylindrical basic shape with a filled central region. Two thread turns 8′ which are provided with an abrasion-resistant coating are arranged on the shell side of the central center region which includes the center axis of the agitator shaft 3′. The flange connection, via which the agitator shaft 3′ is connected directly to the axle of the drive, is indicated at the upper end of the agitator shaft 3′.

FIG. 1d shows a simplified horizontal section through the conventional stirred ball mill 1′ (shown in FIG. 1a). As in FIG. 1b, a simplified illustration has likewise been selected here, in which most of the structural elements are not shown for reasons of clarity, as a result of which substantial differences from the present invention can be seen more clearly. FIG. 1d is a horizontal section through the stirred ball mill 1′ at the level of the agitator shaft 3′. The agitator jar 2′, the interior space of which is configured as a milling chamber 5′, has a square cross section (outline). In FIG. 1d, the thread turn is not shown separately for the single agitator shaft 3′, but merely the maximum cross-sectional area which is claimed by the agitator shaft 3′ is shown, that is to say the outer border of the screw of the agitator shaft 3′ (this is therefore not the crossover sectional area of the agitator shaft 3′ itself, but rather the projection of the agitator shaft 3′ onto the plane of the illustration). Furthermore, the effective diameter of the agitator shaft 3′ is illustrated as a double arrow, and the center axis, running perpendicularly with respect to the plane of the illustration, of the agitator shaft 3′ is illustrated as a cross, the agitator shaft 3′ rotating about said center axis in the rotational direction which is represented by way of a single arrow (here, in the clockwise direction).

FIG. 2 shows diagrammatic illustrations of stirred ball mills in accordance with one embodiment of the present invention, the stirred ball mills having three agitator shafts. FIG. 2a shows a simplified symbolic side view of a stirred ball mill of this type with three agitator shafts, the illustration having been selected and analogously with respect to the illustration in FIG. 1b, with the result that many structural elements are not shown for the sake of improved clarity. The stirred ball mill 1 with a vertically oriented milling jar 2 can be seen in FIG. 2a, in the interior space 5 of which milling jar 2 three agitator shafts 3 with in each case one thread turn 8 are situated. The agitator shafts 3 are arranged in the form of a triangle, two agitator shafts 3 being positioned on the same plane parallel to the plane of the illustration, and a further agitator shaft 3 being positioned centrally in front of them in the viewing direction. A drive 4 is arranged on the milling jar 2, by means of which drive for the three agitator shafts 3 are set in rotation about the center axes. Here, the drive 4 comprises three separate drive units; instead, however, a common drive unit can also be provided which is connected via gear mechanisms to the three agitator shafts 3, or else two drive units, of which one drive unit drives two of the three agitator shafts 3 and the third drive unit drives the third agitator shaft 3. Each drive unit can have a dedicated controller, but a common controller can also be provided, which likewise comprises control of the rotational speeds of the three agitator shafts. The center axes of the three agitator shafts 3 are oriented parallel to one another and do not make contact with one another.

FIG. 2b shows a simplified horizontal section through a stirred ball mill in accordance with the above-described embodiment of the present invention. As in FIG. 1d, this is likewise a simplified illustration, in which most structural elements are not reproduced for reasons of improved clarity, as a result of which substantial differences from the conventional stirred ball mill (shown in FIG. 1d) come to light considerably more clearly. Accordingly, FIG. 2b is also a horizontal section through a stirred ball mill 1 at the level of the three agitator shafts 3. The agitator jar 2, the interior space of which is configured as a milling chamber 5, has a square cross section for improved distinguishability, but all other suitable forms are fundamentally also possible, for example a circular or oval cross section, a regular or irregular polygonal cross section, for example a triangle, a rhombus, a pentagon, hexagon, heptagon, octagon and the like. FIG. 2b does not show the thread turns for the three agitator shafts 3 separately, but merely the maximum crossover sectional areas which are claimed by the agitator shafts 3, that is to say the outer borders of the screws (that is to say, a projection of the outer edges of the thread turns onto the plane of the illustration). Furthermore, the center axes, running perpendicularly with respect to the plane of the illustration, of the agitator shafts 3 are shown as crosses, about which the agitator shafts 3 rotate in the rotational directions which are represented in each case by way of single arrows. In FIG. 2b, all three agitator shafts 3 have the same rotational direction in the clockwise direction, but all three agitator shafts 3 can also have the same rotational direction counter to the clockwise direction, or in each case two of the three agitator shafts can have a common rotational direction and the third can have an opposite rotational direction. The center axes of the three agitator shafts 3 are arranged as side edges of a trigonal prism.

Apart from the configuration of the steering unit with three agitator shafts, the remaining elements of a stirred ball mill 1 according to the invention can be fundamentally selected to be similar to the elements of conventional stirred ball mills; possible embodiments have already been mentioned in conjunction with the general description of the invention and with the description of FIG. 1.

For instance, the stirred ball mill can have, in particular, a horizontally arranged milling jar or a vertically arranged milling jar, and can be configured for a discontinuous, continuous or quasi-continuous procedure in wet operation or in dry operation. The milling jar which is arranged (vertically or horizontally) in the main direction can be formed, for example, from individual segments or can be configured in one piece. The milling chamber typically has a shape which is derived from that of a cylinder or polygonal prism, it being possible for its inner wall to have high-strength linings or coatings made from low-abrasion and wear-resistant materials. A vertically arranged milling jar which is configured for continuous operation as a rule has one or more intakes, for example on the base face or in the vicinity of the base face, wherein a discharge can be provided above the intake, for instance in the upper region of the milling jar. Moreover, the milling jar can have further elements, for example a separate feed opening for fresh milling aid elements, screen units for retaining the milling aid elements, maintenance openings and the like.

The stirred ball mill staring unit comprises the three agitator shafts 3 and the drive 4. Here, the drive has at least one suitable drive unit, for instance a motor, and further components, such as, for instance, units for changing the rotational speed, for example frequency converters, or other control units, for instance those with control electronics or logic circuits, or else machine elements for changing motion variables, for example gear mechanisms. For instance, a separate drive unit can be provided for each agitator axle, but a plurality of agitator shafts or even all agitator shafts can have a common drive unit, it being possible for the actuation of the different drive units to take place via a common controller or via separate controllers.

The three agitator shafts in each case have a center axis which is arranged parallel to the main direction of the milling jar and about which the agitator shafts are configured rotatably, without the three agitator shafts making contact with one another in the process. The agitator shafts are mounted fixedly to the frame in the milling jar, and have thread turns as agitator elements, with the result that the agitator shaft overall are configured as screws, for example as axially arranged single-start or multiple-start screws, for instance as two-start screws, three-start screws or four-start screws, it being possible, for example, for said screws to be those with a cylindrical basic shape and those with a slightly conical basic shape, for them to have a filled center region or unfilled center region, and for them to be right-handed screws or left-handed screws of a respective suitable screw line, screw surface or coil surface, lead and angle. Furthermore, the screws (above all, their thread turn and tip) can have high-strength linings or coatings made from low-abrasion and wear-resistant materials. As is shown in the following comments, more than three agitator shafts can fundamentally also be provided (for example, for agitator shafts, five agitator shafts or six agitator shafts), the center axes of which can then represent the side edges of prisms which have different base areas, for example of a triangle, a square, a pentagon, hexagon or the like. The agitator shaft can be selected to be identical or different and can therefore also have different diameters and screw geometries.

In the case of the comminution of milling material in a stirred ball mill of this type with a vertically arranged milling jar in wet operation, the milling material to be comminuted is first of all suspended in a milling aid liquid, a milling material dispersion being obtained. The milling material dispersion is then introduced continuously into a lower section of the milling chamber of the above-described stirred ball mill, which milling chamber is filled with milling aid elements. The mixture obtained here of milling material dispersion and milling aid elements is stirred/thoroughly mixed by way of the rotational movement of the three vertical agitator shafts which are mounted fixedly to the frame, do not make contact with one another, and are oriented at least substantially vertically parallel to one another, the center axes being arranged as side edges of a prism, namely a trigonal prism. During a rotational movement, the milling material is comminuted and at the same time a part of the milling material dispersion is conveyed continuously out of the lower section of the milling chamber vertically into an upper section of the milling chamber. The processed milling material dispersion which is obtained in this way and in which at least part of the milling material which is dispersed in the milling aid liquid has already been comminuted is finally discharged continuously from the upper section of the milling chamber. Here, the milling aid elements can be separated from the milling material dispersion, for instance with the aid of a screen in front of the discharge of the stirred ball mill. Finally, the comminuted milling material is separated from the discharged milling material dispersion. Possible embodiments of a comminution method of this type have already been mentioned in conjunction with the general description of the invention.

FIG. 3 shows a diagrammatic simplified horizontal sections through stirred ball mills in accordance with further embodiments of the present invention, each stirred ball mill which is shown there having in each case four agitator shafts. The form of simplified illustrations has also been selected here, which form in each case shows horizontal sections through a stirred ball mill 1 at the level of the four agitator shafts 3. FIGS. 3a, 3b, 3c and 3d in each case show agitator jars 2, the interior space of which is configured in each case as a milling chamber 5 which has a square cross section. The thread turns are not shown separately in each case for the four agitator shafts 3, but rather merely the outer boundaries of the screws. The center axes, running perpendicularly with respect to the plane of the illustration, of the agitator shafts are indicated as crosses, about which the agitator shafts 3 rotate in the rotational directions which are represented in each case by way of the singularities. The center axes of the four agitator shafts 3 are arranged in each case as side edges of a prism with a square base area. The four partial illustrations in FIG. 3 differs merely in terms of the rotational direction of the respective four agitator shafts. In FIG. 3a, all four agitator shafts 3 have the same rotational direction (here, in the clockwise direction); in FIG. 3b, three agitator shafts 3 have in each case the same rotational direction (here, counter to the clockwise direction) and one agitator shaft 3 has a rotational direction which is different therefrom (here, in the clockwise direction); in FIGS. 3c and 3d, in each case two agitator shafts 3 have the one rotational direction and the other two agitator shafts 3 have the other rotational direction, the two agitator shafts 3 with the same rotational direction being arranged in each case adjacently with respect to one another in FIG. 3c, whereas adjacent agitator shafts 3 in each case have different rotational directions in FIG. 3d. Apart from the use of four agitator shafts 3 instead of three agitator shafts, the considerations stated in conjunction with FIG. 2 in respect of the structural embodiment and in respect of any design freedoms also apply to the further embodiments shown in FIG. 3; the same applies to the method for comminuting milling material.

FIG. 4 shows diagrammatic simplified horizontal sections through stirred ball mills in accordance with further embodiments of the present invention, each stirred ball mill having in each case five agitator shafts 3, the center axes of which are arranged as side edges of a prism with a regular pentagonal base area. The form of simplified illustrations has also been selected here, which illustrations in each case show horizontal sections through a stirred ball mill 1 at the level of the agitator shafts 3. FIGS. 4a, 4b and 4c in each case show agitator jars 2, the interior space of which is configured in each case as a milling chamber 5 which has a square cross section. FIG. 4a shows a stirred ball mill 1 which has merely five agitator shafts 3 in a pentagonal arrangement; the stirred ball mills 1 which are shown in FIGS. 4b and 4c have, moreover, a sixth agitator shaft which is arranged as an inner agitator shaft 7 in the interior of the pentagon which is defined by the five outer agitator shafts 3. The thread turns are in each case not shown separately for all three agitator shafts 3, 7 in FIG. 4, but rather merely the outer borders of the screws. The center axes, running perpendicularly with respect to the plane of the illustration, of the agitator shafts 3, 7 are indicated as crosses, about which the agitator shafts 3, 7 rotate in the rotational directions which are represented in each case by way of single arrows. In FIGS. 4a, 4b and 4c, the rotational directions are in each case selected to be identical for the five outer agitator shafts 3, but they can fundamentally also be selected to be different. In FIG. 4b, the rotational direction of the inner agitator shaft 7 is different than the rotational directions of the five outer agitator shafts 3, whereas the rotational direction of all six agitator shafts 3, 7 is identical in FIG. 4c. In FIGS. 4b and 4c, the inner agitator shafts 7 have, moreover, diameters which differ from the diameters of the five outer agitator shafts 3 (in FIG. 4b, the inner agitator shaft 7 has a smaller diameter than the five outer agitator shafts 3; in FIG. 4c, in contrast, it has a greater diameter). Instead, the inner agitator shaft can of course also have the same diameter as outer agitator shafts. More than one inner agitator shaft can fundamentally also be provided in the interior space of the prism defined by the center axes of the outer agitator shafts. As an alternative or in addition, the (at least one) inner agitator shaft can be connected to the drive (for instance, to a separate or a common drive unit) or else can have no drive, with the result that it can be set passively in rotation merely via the flow movement of the mixture of milling material dispersion and milling aid elements. Furthermore, the (at least one) inner agitator shaft can also have a braking device, for instance mechanical braking systems, magnetic braking systems, electric braking systems, fluid braking systems or the like. Apart from this, the considerations stated in conjunction with FIG. 2 in respect of the structural embodiment and any design freedoms likewise applied to the further embodiments shown in FIG. 4; the same applies to the method for comminuting milling material.

List of Designations

| | |
|---|---|
| 1 | Stirred ball mill |
| 1′ | Conventional stirred ball mill |
| 2 | Milling jar |
| 2′ | Milling jar of a conventional stirred ball mill |
| 3 | (Outer) agitator shaft |
| 3′ | (Single) agitator shaft of a conventional stirred ball mill |
| 4 | Drive |
| 4′ | Drive of a conventional stirred ball mill |
| 5 | Milling chamber |
| 5′ | Milling chamber of a conventional stirred ball mill |
| 6′ | Drive unit of a conventional stirred ball mill |
| 7 | Inner agitator shaft |
| 8 | Thread turn |
| 8′ | Thread turn of a conventional stirred ball mill |
| 9′ | Intake |
| 10′ | Discharge |
| 11′ | Milling chamber lining |
| X | Center axis |

1.-14. (canceled)

15. A stirred ball mill comprising:
a milling jar arranged in a main direction and having a milling chamber that is configured to receive milling material and milling aid elements;
at least three agitator shafts, each agitator shaft having a center axis that is parallel to the main direction of the milling jar, wherein the center axes of the agitator shafts are arranged as side edges of a prism, wherein each agitator shaft is configured as a screw that is mounted fixedly to a frame in the milling jar such that the agitator shaft is rotatable about the center axis; and
a drive configured to rotate the agitator shafts about their respective center axes without any contact between the agitator shafts.

16. The stirred ball mill of claim 15 wherein the drive comprises a dedicated drive unit for each of the agitator shafts.

17. The stirred ball mill of claim 15 wherein the drive comprises a common drive unit for at least two of the agitator shafts.

18. The stirred ball mill of claim 15 wherein the drive is configured to drive at least one of the agitator shafts at a rotational speed that is regulatable independently of rotational speeds of the other agitator shafts.

19. The stirred ball mill of claim 15 comprising an inner agitator shaft that has a center axis that is parallel to the main direction of the milling jar, wherein the inner agitator shaft is configured as a screw that is mounted fixedly in the milling jar and is configured to rotate about its center axis without contacting any one of the at least three agitator shafts, wherein the center axis of the inner agitator shaft is arranged within the prism that is formed by the center axes of the at least three agitator shafts.

20. The stirred ball mill of claim 19 comprising a braking device that is configured to decrease a rotational speed or prevent rotational movement of the inner agitator shaft.

21. The stirred ball mill of claim 19 wherein the inner agitator shaft is not connected to the drive.

22. The stirred ball mill of claim 19 wherein the drive includes a drive unit that is configured to rotate the inner agitator shaft about its center axis.

23. The stirred ball mill of claim 19 wherein the at least three agitator shafts are configured for rotational movement in a same rotational direction, wherein the inner agitator shaft is configured for rotational movement in a rotational direction that is different than the same rotational direction of the at least three agitator shafts.

24. The stirred ball mill of claim 15 wherein the agitator shafts are configured to rotate in a same rotational direction.

25. The stirred ball mill of claim 15 wherein a first of the agitator shafts is a right-handed screw, wherein a second of the agitator shafts is a left-handed screw.

26. The stirred ball mill of claim 15 wherein an external diameter of each of the agitator shafts is at most half of a maximum internal width of the milling chamber.

27. A stirred ball mill stirring unit for a stirred ball mill, the stirred ball mill stirring unit comprising:
at least three agitator shafts, each of the at least three agitator shafts having a center axis, being configured as a screw that is rotatable about the center axis, and being configured to be fixedly mounted to a frame in a milling jar, wherein the center axes of the at least three agitator shafts are parallel to one another and are arranged as side edges of a prism; and
a drive that is configured to rotate the at least three agitator shafts about their respective center axes without causing any contact between the at least three agitator shafts, wherein either:
the drive comprises a dedicated drive unit for each of the at least three agitator shafts, or
the drive comprises a common drive unit for at least two of the at least three agitator shafts,
wherein the drive is configured to drive at least one of the at least three agitator shafts at a rotational speed that is regulatable independently of rotational speeds of the other of the at least three agitator shafts,
the stirred ball mil stirring unit further comprising an inner agitator shaft that has a center axis that is parallel to a main direction of the milling jar, is configured as a screw that is rotatable about its center axis, and is configured to be fixedly mounted to the frame in a milling jar, wherein the inner agitator shaft is configured so as not to contact any one of the at least three agitator shafts, wherein the center axis of the inner agitator shaft is disposed within the prism formed by the center axes of the at least three agitator shafts,
wherein either the drive is not connected to the inner agitator shaft or the drive includes a drive unit for rotating the inner agitator shaft about its center axis.

28. The stirred ball mill stirring unit of claim 27 comprising a braking device that is configured to decrease a rotational speed or to prevent rotational movement of the inner agitator shaft.

29. The stirred ball mill stirring unit of claim 27 wherein an external diameter of each of the at least three agitator shafts is at most half a maximum internal width of a milling chamber.

30. A method for comminuting milling material, the method comprising:
suspending the milling material to be comminuted in a milling aid liquid, thereby obtaining a milling material dispersion;
continuously introducing the milling material dispersion into a lower section of a milling chamber, filled with milling aid elements, of a stirred ball mill, continuously vertically conveying a part of the milling material dispersion from the lower section of the milling chamber into an upper section of the milling chamber via at least three rotating, vertical agitator shafts that are mounted fixedly to a frame, wherein the agitator shafts do not make contact with one another, are oriented at least substantially vertically parallel to one another, and have center axes that are arranged as side edges of a prism, wherein a processed milling material dispersion is obtained, wherein at least one part of the milling material dispersed in the milling aid liquid is comminuted;
continuously discharging a part of the processed milling material dispersion from the upper section of the milling chamber; and
concluding separating of the comminuted milling material from the discharged processed milling material dispersion.
